(19) United States
(12) Patent Application Publication
(10) Pub. No.: US 2013/0083622 A1
(43) Pub. Date: Apr. 4, 2013

(54) UNDERWATER NODE FOR SEISMIC SURVEYS

(71) Applicants: Philippe HERRMANN, Villepreux (FR); Romain SOUBEYRAN, Paris (FR); Robert DOWLE, Massy (FR)

(72) Inventors: Philippe HERRMANN, Villepreux (FR); Romain SOUBEYRAN, Paris (FR); Robert DOWLE, Massy (FR)

(73) Assignee: CGGVERITAS SERVICES SA, Massy Cedex (FR)

(21) Appl. No.: 13/616,109

(22) Filed: Sep. 14, 2012

Related U.S. Application Data
(60) Provisional application No. 61/541,216, filed on Sep. 30, 2011.

(51) Int. Cl. G01V 1/38; G01V 1/20

(52) U.S. Cl. 367/15; 367/153

(57) ABSTRACT

A method, system and a marine node for recording seismic waves underwater. The node includes a body made of a compressible material that has a density similar to a density of the water; a first sensor located in the body and configured to record pressure waves; and a second sensor located in the body and configured to record three dimensional movements. The body is coupled to the water for passing the seismic waves to the first and second sensors.

### RELATED APPLICATION

The present application is related to, and claims priority from U.S. Provisional Patent Application No. 61/541,216, filed Sep. 30, 2011, entitled “UNDERWATER NODE FOR SEISMIC SURVEYS,” the disclosure of which is incorporated herein by reference.

### BACKGROUND

1. Technical Field

Embodiments of the subject matter disclosed herein generally relate to methods and systems and, more particularly, to mechanisms and techniques for performing a marine seismic survey using underwater nodes that carry appropriate seismic sensors.

2. Discussion of the Background

Marine seismic data acquisition and processing generate a profile (image) of a geophysical structure under the seafloor. While this profile does not provide an accurate location of oil and gas reservoirs, it suggests, to those trained in the field, the presence or absence of these reservoirs. Thus, providing a high-resolution image of the geophysical structures under the seafloor is an ongoing process.

Reflection seismology is a method of geophysical exploration to determine the properties of earth's subsurface, which are especially helpful in the oil and gas industry. Marine reflection seismology is based on using a controlled source of energy that sends the energy into the earth. By measuring the time it takes for the reflections to come back to plural receivers, it is possible to evaluate the depth of features causing such reflections. These features may be associated with subterranean hydrocarbon deposits.

A traditional system for generating the seismic waves and recording their reflections off the geological structures present in the subsurface is illustrated in FIG. 1. A vessel 10 tows an array of seismic receivers 11 provided on streamers 12. The streamers may be disposed horizontally, i.e., lying at a constant depth relative to a surface 14 of the ocean. The streamers may be disposed to have other than horizontal spatial arrangements. The vessel 10 also tows a seismic source array 16 that is configured to generate a seismic wave 18. The seismic wave 18 propagates downwards toward the seafloor 20 and penetrates the seafloor until eventually a reflecting structure 22 (reflector) reflects the seismic wave. The reflected seismic wave 24 propagates upwardly until it is detected by the receiver 11 on the streamer 12. Based on the data collected by the receiver 11, an image of the subsurface is generated by further analyses of the collected data.

The seismic source array 16 includes plural individual source elements. The individual source elements may be distributed in various patterns, e.g., circular, linear, at various depths in the water. FIG. 2 shows a vessel 40 towing two cables 42 provided at respective ends with deflectors 44. Plural lead-in cables 46 are connected to streamers 50. The plural lead-in cables 46 also connect to the vessel 40. The streamers 50 are maintained at desired separations from each other by separation ropes 48. Plural individual source elements 52 are also connected to the vessel 40 and to the lead-in cables 46 via ropes 54.

However, this traditional configuration is expensive as the cost of the streamers is high. In addition, this configuration might not provide accurate results as a coupling between the seismic receivers and the seabed is poor. To overcome this last problem, new technologies deploy plural seismic sensors on the bottom of the ocean to improve the coupling.

One such new technology is ocean bottom station (OBS) nodes. OBS are capable to provide better data than conventional acquisition systems because of their wide-azimuth geometry. Wide-azimuth coverage is helpful for imaging beneath complex overburden like that associated with salt bodies. Salt bodies act like huge lenses distorting seismic waves propagating through them. To image subsalt targets, it is preferable to have the capability to image through complex overburdens, but even the best imaging technology alone is not enough. A good illumination of the targets is necessary. Conventional streamer surveys are operated with a single seismic vessel and have a narrow azimuthal coverage. If either the source or the receiver is located above an overburden anomaly, the illumination of some targets is likely to be poor. OBS nodes can achieve wide-azimuth geometry.

Additionally, OBS nodes are much more practical in the presence of obstacles such as production facilities. For the purpose of seismic monitoring with repeat surveys (4D), OBS have better positioning repeatability than streamers. Also, OBS provide multi-component data. Such data can be used for separating up- and down-going waves at the seabed which is useful for multiple attenuations and for imaging using the multiples. In addition, multi-component data allow recording shear waves which provide additional information about lithology and fractures, and sometimes allow to image targets which have low reflectivity or are under gas clouds.

U.S. Pat. No. 6,932,185, the entire content of which is incorporated herein by reference, discloses this kind of nodes. In this case, the seismic sensors 60 are attached, as shown in FIG. 3 (which corresponds to FIG. 4 of the patent), to a heavy pedestal 62. A station 64 that includes the sensors 60 is launched from a vessel and arrives due to its gravity, to a desired position. The station 64 remains on the bottom of the ocean permanently. Data recorded by sensors 60 are transferred through a cable 66 to a mobile station 68. When necessary, the mobile station 68 may be brought to the surface to retrieve the data.

Although this method provides a better coupling between the seabed and the sensors, the method is still expensive and not flexible as the stations and corresponding sensors are left on the seabed.

An improvement to this method is described, for example, in European Patent No. EP 1 217 390, the entire content of which is incorporated herein by reference. In this document, a sensor 70 (see FIG. 4) is removably attached to a pedestal 72 together with a memory device 74. After recording the seismic waves, the sensor 70 together with the memory device 74 are instructed by a vessel 76 to detach from the pedestal 72 and to surface at the ocean surface 78 to be picked up by the vessel 76.

However, this configuration is not very reliable as the mechanism maintaining the sensor 70 connected to the pedestal 72 may fail to release the sensor 70. Also, the sensor 70 and pedestal 72 may not achieve their intended positions on the bottom of the ocean. Further, the fact that the pedestals 72 are left behind contribute to ocean pollution and price increase, which are both undesirable.

Accordingly, it would be desirable to provide systems and methods that provide inexpensive and non-polluting nodes for reaching the seabed, and recording seismic waves.

### SUMMARY

According to one exemplary embodiment, there is a marine node for recording seismic waves underwater. The node includes a spherical body made of a compressible material that has a density similar to a density of the water; a first sensor located in the body and configured to record pressure waves; and a second sensor located in the body and configured to record three dimensional movements. The body is coupled to the water for passing the seismic waves to the first and second sensors.

According to another exemplary embodiment, there is a marine node for recording seismic waves underwater. The node includes a body made of a compressible material that has a density similar to a density of the water; a first sensor located in the body and configured to record pressure waves; and a second sensor located in the body and configured to record three dimensional movements. The body is coupled to the water for passing the pressure waves and the three dimensional movements to the first and second sensors.

According to still another exemplary embodiment, there is a system for recording seismic waves underwater. The system includes an autonomous underwater vehicle (AUV) having a flooding payload bay; and a node located in the payload bay. The node includes a spherical body made of a compressible material that has a density similar to a density of the water; a first sensor located in the body and configured to record pressure waves; and a second sensor located in the body and configured to record three dimensional movements. The body is coupled to the water for passing the pressure waves and the three dimensional movements to the first and second sensors.

According to yet another exemplary embodiment, there is a method for recording seismic waves underwater. The method includes a step of deploying a node underwater, the node having a body made of a compressible material that has a density similar to a density of the water; a step of coupling the body to the water for passing pressure waves and three-dimensional movements through the body; a step of recording the pressure waves with a first sensor located in the body; and a step of recording the three-dimensional movements with a second sensor located in the body.

### BRIEF DESCRIPTION OF THE DRAWINGS

The accompanying drawings, which are incorporated in and constitute a part of the specification, illustrate one or more embodiments and, together with the description, explain these embodiments. In the drawings:

FIG. 1 is a schematic diagram of a conventional seismic survey system;

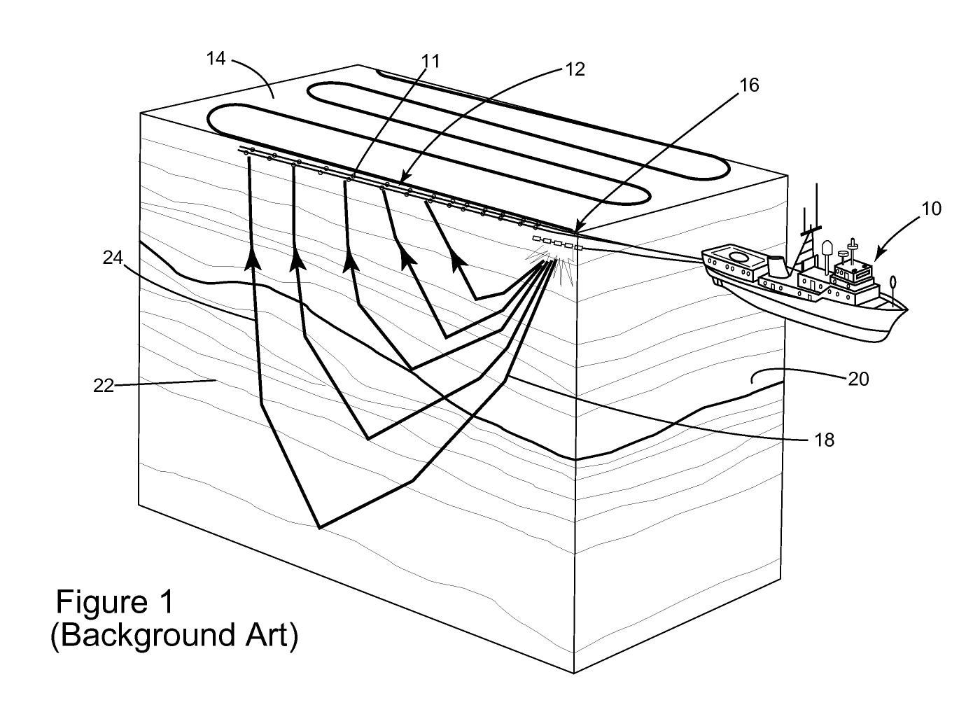

FIG. 2 illustrates a traditional arrangement of streamers and source arrays towed by a vessel;

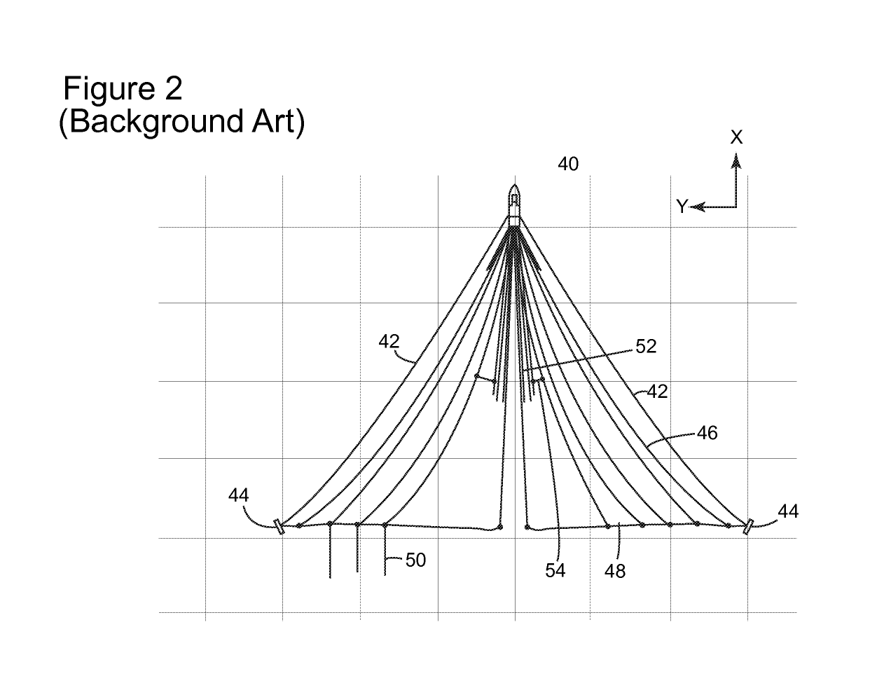

FIG. 3 is a schematic diagram of a station that may be positioned on the bottom of the ocean for seismic data recording;

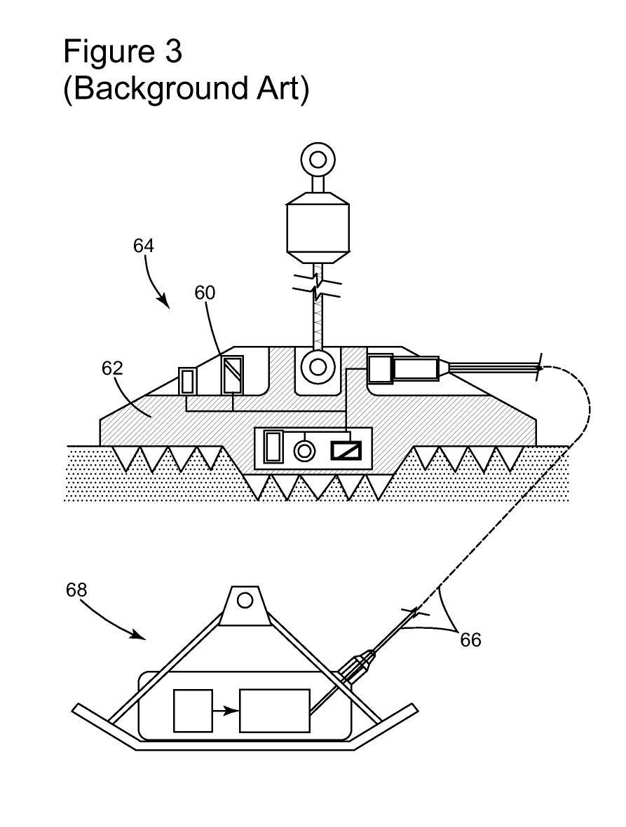

FIG. 4 is a schematic diagram of another station that may be positioned on the bottom of the ocean for seismic data recording;

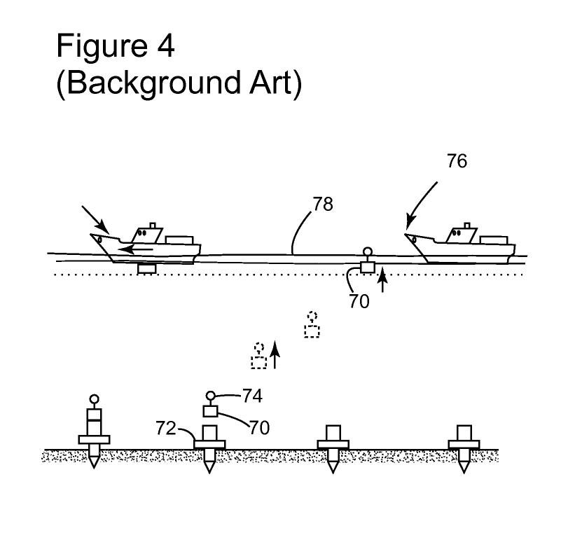

FIG. 5 is a schematic diagram of a node with openings according to an exemplary embodiment;

FIG. 6 is a schematic diagram of a node with no openings according to an exemplary embodiment;

FIG. 7 is a schematic diagram of a node having a compressible body according to an exemplary embodiment;

FIG. 8 is a schematic diagram of a node having a spherical body according to an exemplary embodiment;

FIG. 9 is a schematic diagram of a node having at least one sensor inside a solid body according to an exemplary embodiment;

FIG. 10 is a schematic diagram of a node having regions with different densities according to an exemplary embodiment;

FIG. 11 is a schematic diagram of an AUV carrying a node according to an exemplary embodiment;

FIG. 12 is a schematic diagram of an AUV towing a node according to an exemplary embodiment;

FIG. 13 is a schematic diagram of an AUV according to an exemplary embodiment;

FIG. 14 is a schematic diagram of another AUV according to an exemplary embodiment; and

FIG. 15 is a flowchart of a method for deploying and recovering a node on an AUV according to an exemplary embodiment.

### DETAILED DESCRIPTION

The following description of the exemplary embodiments refers to the accompanying drawings. The same reference numbers in different drawings identify the same or similar elements. The following detailed description does not limit the invention. Instead, the scope of the invention is defined by the appended claims. The following embodiments are discussed, for simplicity, with regard to the terminology and structure of a node having seismic sensors and being deployed under water for performing seismic recordings. However, the embodiments to be discussed next are not limited to an independent node, but may be applied to nodes attached to an autonomous underwater vehicle (AUV) or other platforms, e.g., a glider.

Reference throughout the specification to “one embodiment” or “an embodiment” means that a particular feature, structure or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments.

Emerging technologies in marine seismic surveys need an inexpensive system for deploying and recovering seismic receivers at the bottom of the ocean. According to an exemplary embodiment, such a seismic system includes plural nodes each having one or more seismic sensors. The seismic sensors may be one of a hydrophone, geophone, accelerometers, electromagnetic sensors, etc. If an electromagnetic sensor is used, then a source that emits electromagnetic waves may be used instead or in addition to an acoustic source.

A node may be deployed by itself or by using an AUV. The node may be the payload of the AUV or may be linked to the AUV. The AUV may be a specially designed device or an off-the-shelf device so that it is inexpensive. The off-the-shelf device may be quickly retrofitted or modified to receive the node. A deployment vessel stores the nodes and/or AUVs and launches them as necessary for the seismic survey. The nodes and/or AUVs find their desired positions (preprogrammed in their local control device) using, for example, an inertial navigation system.

In one embodiment, the node has a spherical shape and it is made of a material that has a density close to the water density. The material may also be compressible so that acoustic waves may be transmitted from the water to the sensors inside the node. Thus, in one application, the node is coupled to water and not to the seabed. The node may include a hydrophone and three geophones, thus, being a 4C (four component) seismic sensor. Other combinations of seismic sensors are possible. In one application, the spherical node is rigid but still compressible. A weight distribution of the spherical node may be implemented such that a mass of a bottom part of the node is larger than a mass of a top part. This feature ensures a given directionality of the node. The node may be deployed with the AUV. The AUV may have a flooding payload bay in which the node is provided or the AUV may tow the node. In this last case, the node may be located in a flooding cage. The node may also be deployed by itself.

As the deployment vessel is launching the nodes and/or AUVs, a shooting vessel may follow the deployment vessel for generating seismic waves. The shooting vessel may tow one or more seismic source arrays. The shooting vessel or another vessel, e.g., the recovery vessel, may then instruct selected nodes and/or AUVs to resurface so that they can be collected. In one embodiment, the deployment vessel also tows source arrays and shoots them as it deploys the nodes and/or AUVs. In still another exemplary embodiment, only the deployment vessel is configured to retrieve the nodes and/or AUVs. However, it is possible that only the shooting vessel is configured to retrieve the nodes and/or AUVs. Alternatively, a dedicated recovery vessel may wake-up the nodes and/or AUVs and instruct them to return to the surface for recovery.

In one exemplary embodiment, the number of nodes and/or AUVs is in the thousands. Thus, the deployment vessel is configured to hold all of them at the beginning of the survey and then to launch them as the seismic survey is advancing. If the shooting vessel is configured to retrieve the nodes and/or AUVs, when the number of available nodes and/or AUVs at the deployment vessel is below a predetermined threshold, the shooting vessel and the deployment vessel are instructed to switch positions in the middle of the seismic survey. If a dedicated recovery vessel is used to recover the nodes and/or AUVs, then the deployment vessel is configured to switch positions with the recovery vessel when the deployment vessel becomes empty.

In an exemplary embodiment, the seismic survey is performed as a combination of seismic sensors located on the nodes and on streamers towed by the deployment vessel, or the shooting vessel or by both of them.

In still another exemplary embodiment, when selected nodes and/or AUVs are instructed to surface, they may be programmed to go to a desired rendezvous point where they will be collected by the shooting vessel or by the deployment vessel or by the recovery vessel. The selected nodes and/or AUVs may be chosen to belong to a given row or column if a row and column arrangement is used. The shooting or/and deployment or recovery vessel may be configured to send acoustic signals to the returning nodes and/or AUVs for guiding them to the desired position. The AUVs may be configured to rise to a given altitude, follow the return back path at that altitude and then surface for being recovered. In one exemplary embodiment, the nodes and/or AUVs are configured to communicate among them so that they follow each other in their path back to the recovery vessel or they communicate among them to establish a queuing line for being retrieved by the shooting or recovery or deployment vessel.

Once on the vessel, the nodes and/or the AUVs are checked for problems, their batteries may be recharged or replaced and the stored seismic data may be transferred for processing. The recovery vessel may store the nodes and/or AUVs on deck during maintenance phase or somewhere inside the vessel. A continuous conveyor-type mechanism may be designed to recover the nodes and/or AUVs on one side of the vessel, when the vessel is used as a recovery vessel, and to launch the nodes and/or AUVs on another side of the vessel when the vessel is used as a deployment vessel. After this maintenance phase, the nodes and/or AUVs are again deployed as the seismic survey continues. Thus, in one exemplary embodiment the nodes and/or AUVs are continuously deployed and retrieved. In still another exemplary embodiment, the nodes and/or AUVs are configured to not transmit the seismic data to the deployment or recovery or shooting vessel while performing the seismic survey. This may be advantageous as the available electric power of the node and/or AUV is limited. In another exemplary embodiment, each node and/or AUV has enough electric power (stored in the battery) to only be deployed, record seismic data and resurface to be retrieved. Thus, reducing the data transmission amount between the node and/or AUV and the vessel conserves the power and allows the node and/or AUV to be retrieved on the vessel before running out of power.

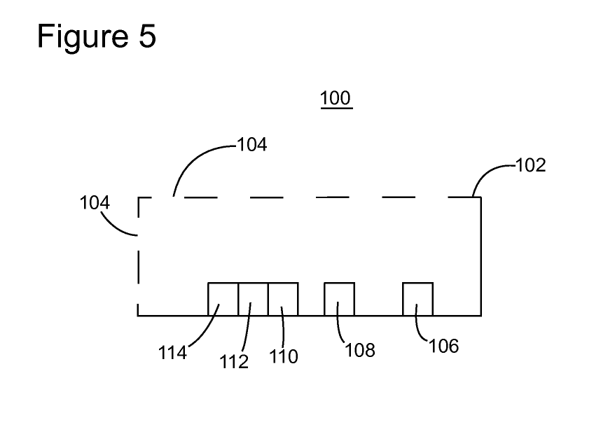

The above-noted embodiments are now discussed in more detail with regard to the figures. FIG. 5 illustrates a node 100 having a body 102 with one or more openings 104. The openings 104 are configured to allow water to enter inside the body 102 to contact the hydrophone 106 and the geophones 108. The body 102 of the node may also include a processor 110, a storage device 112 for storing data recorded by the seismic sensors 106 and 108, and a battery 114 for powering these elements. The node 100 may be released by itself to the seabed or may be carried by an AUV as will be discussed later.

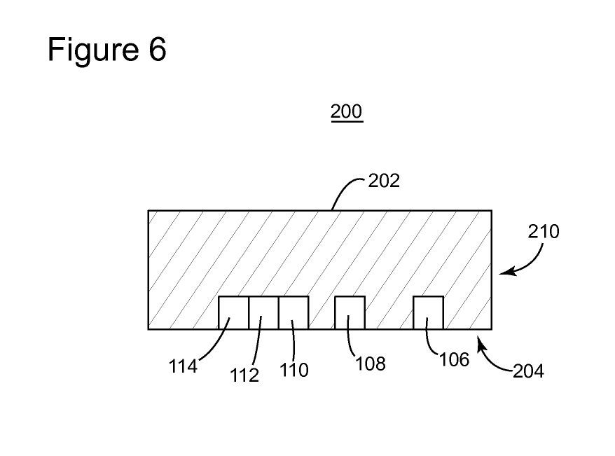

According to an exemplary embodiment illustrated in FIG. 6, a node 200 has the same structure as the node 100 shown in FIG. 5 but no openings in the body 202. According to this exemplary embodiment, water does not penetrate inside the body 102. For this reason, the body 102 is solid, i.e., does not have a cavity in which the sensors 106 and 108 are located as in FIG. 5. This means, that a pressure wave propagates from water 210, around the body 202, through the body 202 to the sensors 106 and 108.

Thus, the body 202 of the node 200 may be made of a solid or liquid like material and it is compressible. Further, a density of the body 202 is around the density of the water so that the body 202 is “invisible” to propagating acoustic waves in water. Such a material may be a composite material. A compressible body allows the acoustic waves reflected from the subsurface to propagate to the sensors 106 and 108 with minimal distortion.

Thus, a coupling between the water 210 and the sensors 106 and 108 is achieved. From this point of view, it is noted that the traditional nodes employ a seabed-sensor coupling and not a sea water-sensor coupling as in this embodiment.

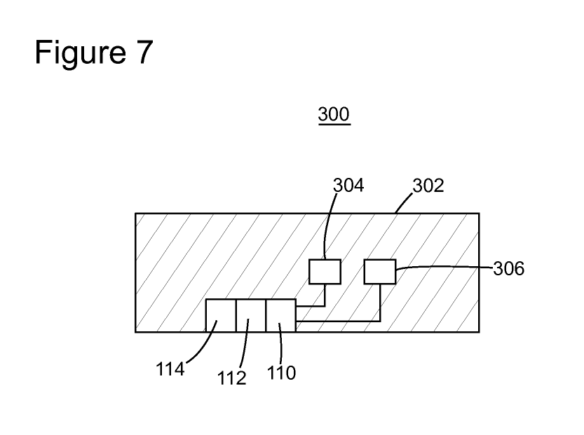

FIG. 6 shows the sensors 106 and 108 being located at an interface between the sea water 210 and a wall 204 of the body 202. However, as shown in FIG. 7, a node 300 may have the sensors 304 and 306 located completely inside the body 302. The same is true for elements 110, 112, 114.

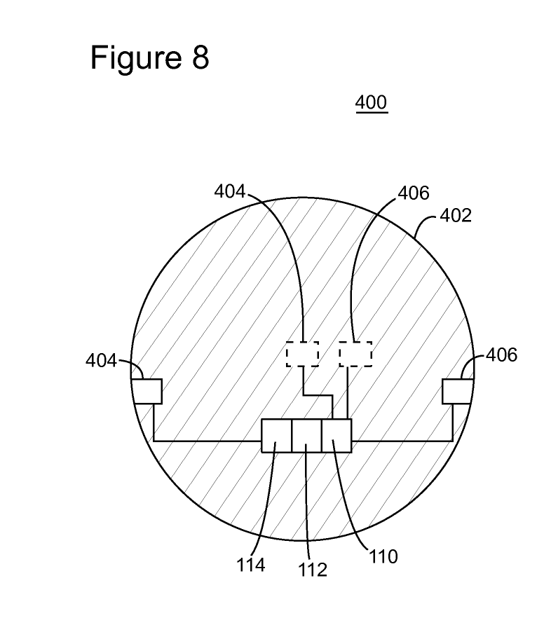

According to another exemplary embodiment illustrated in FIG. 8, a node 400 may have a spherical body 402. The body 402 is made of a material that is compressible. The material may have a density around the water density, e.g., +/−20 or 30%. Thus, the spherical body 402 is neutral (invisible) to water. The sensors 404 and 406 may be located at the interface between water and body 402 or completely inside the body 402.

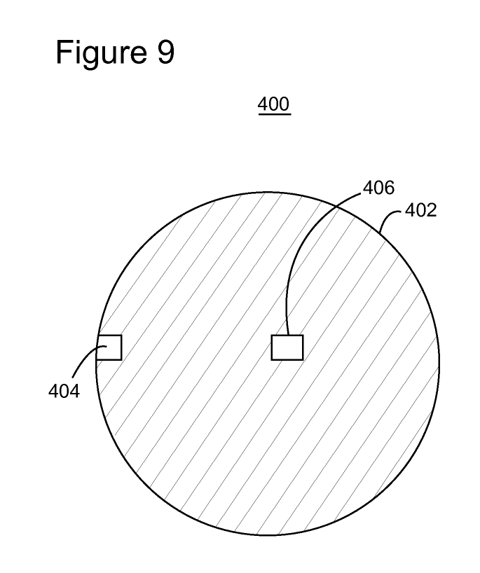

In this exemplary embodiment, the spherical node is coupled to water and not to the seabed. The water coupling allows only the P-waves to propagate to the sensors 404 and 406 and not the S-waves. In one application, the geophones 406 are inside the body 402 and the hydrophone 404 is on the side, to directly couple to the water. Such an embodiment is illustrated in FIG. 9. The elements 110, 112 and 114 are omitted for simplicity.

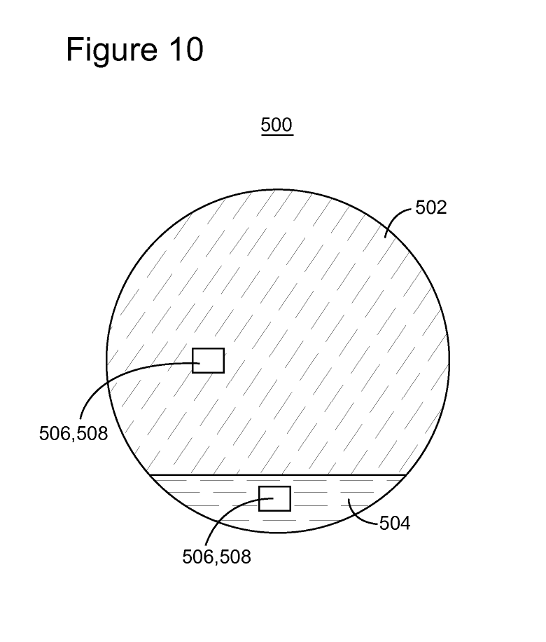

According to an exemplary embodiment illustrated in FIG. 10, the spherical body of a node 500 may be made of two different materials. For example, a top part 502 may be made of a material having a water-like density while a bottom part 504 may be made of a material having a larger density. In this way, the node 500 achieves a vertical directionality due to gravity. The sensors 506 and 508 may be placed in either part of the body or in different parts of the body.

For deploying the node, a few approaches are possible. One approach is to release (simply drop) the node from a deployment vessel without any guidance. Another approach is lower the node with a crane to a desired position. While the first approach is inaccurate, the second approach is slow.

According to an exemplary embodiment, the nodes may be loaded in a remotely operated vehicle (ROV) and deployed at the desired seabed positions with high accuracy.

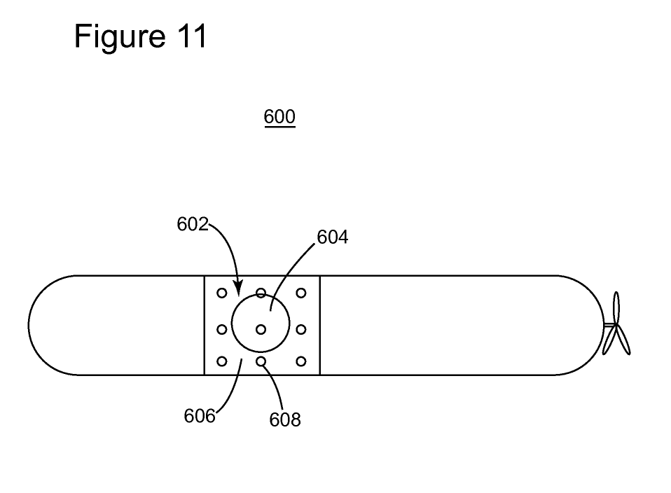

According to another exemplary embodiment, the nodes may be provided on corresponding AUVs. In this case, the AUV has the necessary equipment for driving the node to the desired seabed position. FIG. 11 illustrates an AUV 600 having a payload bay 602 in which a spherical node 604 is loaded. The payload bay 602 is covered by a covering 606 to maintain the spherical node 604 inside the bay 602. The covering 606 may be a net or may have holes 608 so that water freely enters the payload bay 602. Thus, the AUV 600 is used to deliver the node 604 to any desired location and to retrieve the node to a recovery vessel.

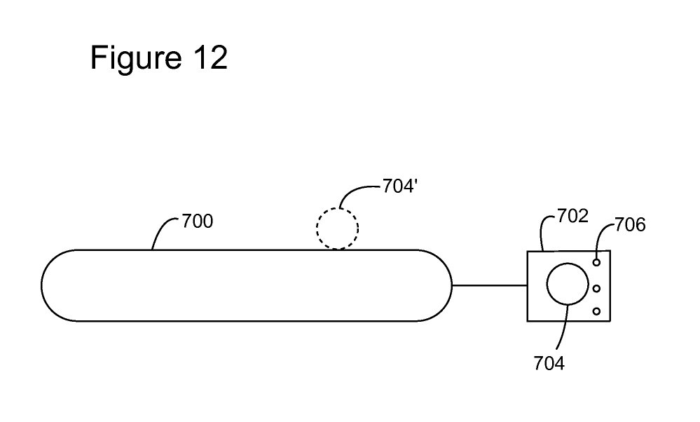

In another exemplary embodiment illustrated in FIG. 12, an AUV 700 tows a cage 702 in which a spherical node 704 is located. The cage 702 may have openings 706 for allowing the seawater to contact the node 704. The cage 702 may be delivered to the seabed for the seismic recordings or may be towed while recording the seismic waves. An alternate node 704′ may be attached on an outside of the AUV by means know by those skilled in the art.

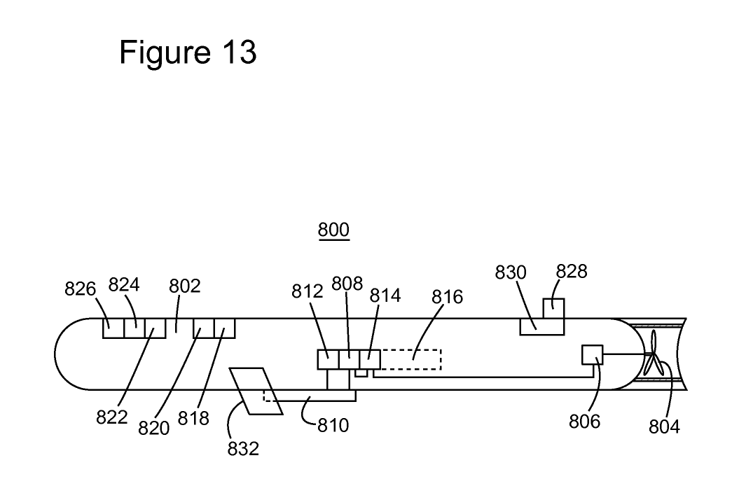

For completeness, the structure of an AUV is now discussed. FIG. 13 illustrates an AUV 800 having a body 802 to which one or more propellers 804 are attached. A motor 806 is provided inside the body 802 for activating the propeller 804. The motor 806 may be controlled by a processor 808. The processor 808 may also be connected to a seismic sensor 810. The seismic sensor 810 may have such a shape that when the AUV lands on the ocean bottom, the seismic sensor achieves a good coupling with the sediments on the ocean bottom. The seismic sensor may include one or more a hydrophone, geophone, accelerometer, etc. For example, if a 4C (four component) survey is desired, the seismic sensor 810 includes three accelerometers and a hydrophone, i.e., a total of four sensors. Alternatively, the seismic sensor may include three geophones and a hydrophone. Of course other combinations of sensors are possible.

A memory unit 812 may be connected to the processor 808 and/or the seismic sensor 810 for storing seismic data recorded by the seismic sensor 810. A battery 814 may be used to power up all these components. The battery 814 may be allowed to change its position along a track 816 to change a center of gravity of the AUV.

The AUV may also include an inertial navigation system (INS) 818 configured to guide the AUV to a desired location. An inertial navigation system includes at least a module containing accelerometers, gyroscopes, or other motion-sensing devices. The INS is initially provided with the position and velocity of the AUV from another source, for example, a human operator, a GPS satellite receiver, etc., and thereafter the INS computes its own updated position and velocity by integrating information received from its motion sensors. The advantage of an INS is that it requires no external references in order to determine its position, orientation, or velocity once it has been initialized. Further, the usage of the INS is inexpensive.

Besides the INS 818, the AUV may include a compass 820 and other sensors 822, as for example, an altimeter for measuring its altitude, a pressure gauge, an interrogator mode, etc. The AUV 800 may optionally include an obstacle avoidance system 824 and a wi-fi device 826. One or more of these elements may be linked to the processor 808. The AUV further includes an antenna 828 and a corresponding acoustic system 830 for communicating with the deploying, recovery or shooting vessel. Stabilizing fins and/or wings 832 for guiding the AUV to the desired position may be used together with the propeller 804 for steering the AUV.

The acoustic system 830 may be an Ultra-short baseline (USBL) system, also sometimes known as Super Short Base Line (SSBL). This system uses a method of underwater acoustic positioning. A complete USBL system includes a transceiver, which is mounted on a pole under a vessel, and a transponder/responder on the AUV. A processor is used to calculate a position from the ranges and bearings measured by the transceiver. For example, an acoustic pulse is transmitted by the transceiver and detected by the subsea transponder, which replies with its own acoustic pulse. This return pulse is detected by the transceiver on the vessel. The time from the transmission of the initial acoustic pulse until the reply is detected is measured by the USBL system and is converted into a range. To calculate a subsea position, the USBL calculates both a range and an angle from the transceiver to the subsea AUV. Angles are measured by the transceiver, which contains an array of transducers. The transceiver head normally contains three or more transducers separated by a baseline of, e.g., 10 cm or less.

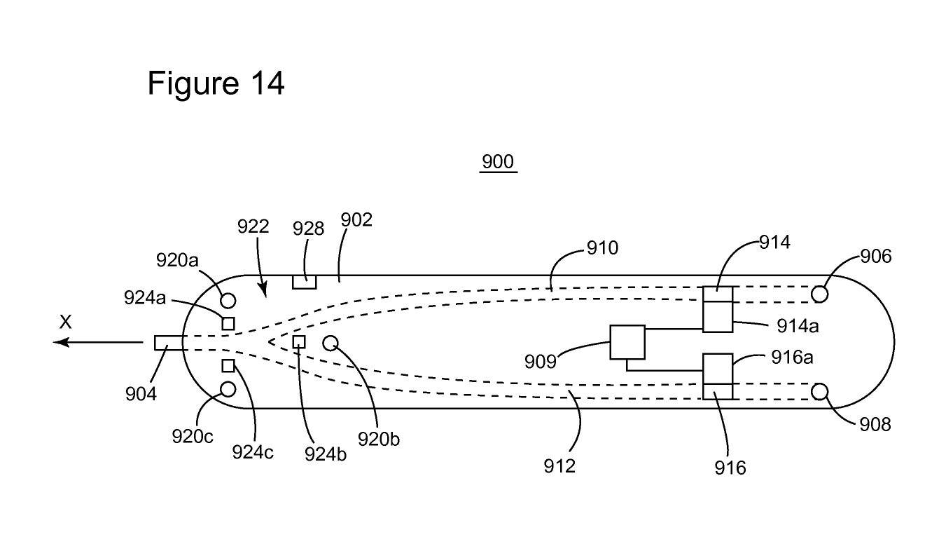

According to another exemplary embodiment illustrated in FIG. 14, an AUV 900 also has a submarine type body with no elements coming out of the body 902. For propulsion, the AUV 900 uses an intake water element 904 and two propulsion nozzles 906 and 908. Appropriate piping 910 and 912 connects the intake water element 904 to the propulsion nozzles 906 and 908. Impellers 914 and 916 may be located in each pipe and connected to DC motors 914a and 916a, respectively, for forcing the water received from the intake water element 904 to exit with a controlled speed at the propulsion nozzles 906 and 908. The two DC motors may be brushless motors and they may be connected to the processor 909 for controlling a speed of the impellers. The impellers may be controlled independently from one another. Also, the impellers may be controlled to rotate in opposite directions (e.g., impeller 914 clockwise and impeller 916 counterclockwise) for maintaining a stability of the AUV.

If this propelling mechanism is not enough for steering the AUV, guidance nozzles 920a-c may be provided on the bow part 922 of the AUV as shown in FIG. 14. The guidance nozzles 920a-c may be located on sides or corners of a triangle that lays in a plane perpendicular on a longitudinal axis X of the AUV. One or three pump jets 924a-c may be also provided inside the body 902 for ejecting water through the guidance nozzles. In this way, a position of the bow of the AUV may be modified/changed while the AUV is moving through the water.

With regard to the shape of the AUV, it was noted below that one possible shape is the shape of a submarine. However, this shape may have various cross sections. For example, a cross-section of the AUV may be circular. In one exemplary embodiment, the cross-section of the AUV is close to a triangle. Of course, other shapes may be imagined that could be handled by a launching device.

A communication between the AUV and a vessel (deployment, recovery, or shooting vessel) may take place based on various technologies, i.e., acoustic waves, electromagnetic waves, etc. According to an exemplary embodiment, a Hi PAP system may be used. The Hi PAP system may be installed on any one of the participating vessels and may communicate with the acoustic system 930 of the AUV.

The Hi PAP system exhibits high accuracy and long range performance in both positioning and telemetry modes. These features are obtained due to the automatic beam forming transducers which focuses the sensitivity towards its targets or transponders. This beam can not only be pointed in any direction below the vessel, but also horizontally and even upwards to the surface as the transducer has the shape of a sphere.

Thus, Hi PAP is a hydro-acoustic Super Short Base Line (SSBL) or USBL, towfish tracking system, able to operate in shallow and deepwater areas to proven ranges in excess of 3000 meters. It is a multi-purpose system used for a wide range of applications including towfish and towed platform tracking, high accuracy subsea positioning and telemetry and scientific research.

The Hi PAP is used to determine the AUV position. In one embodiment, the actual AUV's position is measured with the Hi PAP and is then provided to the AUV, while gliding to its desired position, to correct its INS trajectory.

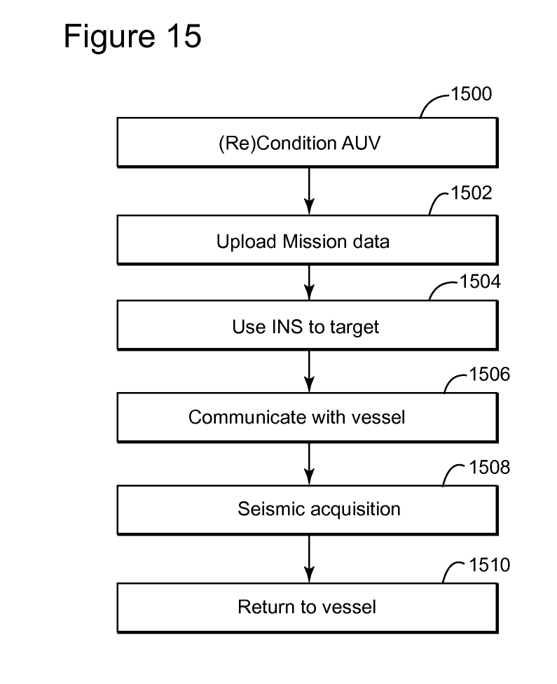

A method for deploying and recovering the nodes with the help of AUVs is now discussed with regard to the flowchart presented in FIG. 15. In step 1500 the node and AUV are prepared for launching. This preparation phase, i.e., conditioning of the node and AUV if they are launched for the first time or reconditioning if the node and AUV are recycled, may include one or more of charging the batteries, downloading seismic data, checking the system, etc.

In the next step 1502, the mission data for that specific node and AUV is loaded in the AUV processor. This may take place while the AUV is on the deck of the vessel or the AUV is already loaded in its launching tube or ramp. The mission data may include the present position of the AUV, the final desired position on the bottom of the ocean, and other parameters. After this, the node and the AUV are launched in step 1504. The AUV is configured to use its INS and the uploaded mission data to travel to its final destination. In one application, the AUV does not receive any information from the vessel while travelling. However, in another application, the AUV may receive additional information from the vessel, for example, its current position as measured by the Hi PAP of the vessel. In still another application, beacons may be used to guide the AUV. In still another application, some of the already deployed AUV may function as beacons.

In step 1506, after the AUV has settled to the bottom of the ocean, the vessel interrogates the AUV about its position. The AUV replies with a reference beam to the AUV and the Hi PAP of the vessel determined the position of the AUV. The position of the AUV may be determined with an accuracy of, for example, +/−2 m when the AUV is at a depth not larger than 300 m.

After this step, the node is ready to record seismic signals in step 1508. This process may last as long as necessary. In one application, after the shooting vessel has triggered its source arrays in a predetermined vicinity of the AUV, the AUV is instructed in step 1510, for example, using the Hi PAP of the vessel to wake up and start resurfacing. During this step the AUV starts its motor and moves towards the recovery vessel. In one application, the recovery vessel is the same with the deployment vessel. The AUV is helped to arrive at the recovery vessel by acoustic signals emitted by the recovery vessel. Once the AUV arrives at the recovery vessel, the AUV engages the recovery unit (e.g., chute) of the recovery vessel and the AUV is handled to arrive on the deck of the vessel for reconditioning as described in step 1500. The node and the AUV may also be delivered under the deck of the recovery vessel for the reconditioning (maintenance) phase. Then, the whole process may be repeated so that the nodes and/or AUVs are constantly reused undersea for the seismic survey.

One or more of the exemplary embodiments discussed above disclose a node configured to perform seismic recordings. It should be understood that this description is not intended to limit the invention. On the contrary, the exemplary embodiments are intended to cover alternatives, modifications and equivalents, which are included in the spirit and scope of the invention as defined by the appended claims. Further, in the detailed description of the exemplary embodiments, numerous specific details are set forth in order to provide a comprehensive understanding of the claimed invention. However, one skilled in the art would understand that various embodiments may be practiced without such specific details.

Although the features and elements of the present exemplary embodiments are described in the embodiments in particular combinations, each feature or element can be used alone without the other features and elements of the embodiments or in various combinations with or without other features and elements disclosed herein.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

What is claimed is:

1. A marine node for recording seismic waves underwater, the node comprising:
a spherical body made of a compressible material that has a density similar to a density of the water;
a first sensor located in the body and configured to record pressure waves; and
a second sensor located in the body and configured to record three dimensional movements,
wherein the body is coupled to the water for passing the pressure waves and the three dimensional movements to the first and second sensors.

2. The node of claim 1, wherein the first sensor is a hydrophone.

3. The node of claim 2, wherein a side of the hydrophone is directly exposed to the water.

4. The node of claim 1, wherein the second sensor includes three geophones.

5. The node of claim 4, wherein the three geophones are located inside the body with no direct contact with the water.

6. The node of claim 1, wherein a first part of the body has a higher density than a second part of the body.

7. The node of claim 1, wherein the body is free of empty chambers.

8. The node of claim 1, further comprising:
a processor connected to the first and second sensors;
a storage device connected to the processor and configured to store data recorded by the first and second sensors; and
a battery configured to power the processor, the first and second sensors, and the storage device.

9. A marine node for recording seismic waves underwater, the node comprising:
a body made of a compressible material that has a density similar to a density of the water;
a first sensor located in the body and configured to record pressure waves; and
a second sensor located in the body and configured to record three dimensional movements,
wherein the body is coupled to the water for passing the pressure waves and the three dimensional movements to the first and second sensors.

10. The node of claim 9, wherein the first sensor is a hydrophone.

11. The node of claim 10, wherein a side of the hydrophone is directly exposed to the water.

12. The node of claim 9 wherein the second sensor includes three geophones.

13. The node of claim 12, wherein the three geophones are located inside the body with no direct contact with the water.

14. A system for recording seismic waves underwater, the system comprising:
an autonomous underwater vehicle (AUV) having a flooding payload bay; and
a node located in the payload bay,
wherein the node comprises,
a spherical body made of a compressible material that has a density similar to a density of the water;
a first sensor located in the body and configured to record pressure waves; and
a second sensor located in the body and configured to record three dimensional movements,
wherein the body is coupled to the water for passing the pressure waves and the three dimensional movements to the first and second sensors.

15. The system of claim 14, wherein the payload bay is covered with a cover so that the node remains inside the payload bay while the AUV travels underwater.

16. The system of claim 15, wherein the cover has plural holes for allowing the water to contact the body.

17. The system of claim 14, wherein the payload bay is a cage that is towed by the AUV.

18. The system of claim 17, wherein the cage is configured to host the node and allow the water to reach the node.

19. The system of claim 17, wherein a first part of the body has a higher density than a second part of the body.

20. A method for recording seismic waves underwater, the method comprising:
deploying a node underwater, the node having a body made of a compressible material that has a density similar to a density of the water;
coupling the body to the water for passing pressure waves and three-dimensional movements through the body;
recording the pressure waves with a first sensor located in the body; and
recording the three-dimensional movements with a second sensor located in the body.
